(19) United States
(12) Patent Application Publication
(10) Pub. No.: US 2012/0291265 A1
(43) Pub. Date: Nov. 22, 2012

(54) Pressing Device

(75) Inventors: Chian-Jung CHEN, Kaohsiung City (TW); Ching-Feng Hsieh, Taipei (TW)

(73) Assignee: Askey Computer Corporation, New Taipei City (TW)

(21) Appl. No.: 13/243,247

(22) Filed: Sep. 23, 2011

(30) Foreign Application Priority Data
May 19, 2011 (TW) 100208944

(51) Int. Cl. B23P 19/00

(52) U.S. Cl. 29/700

(57) ABSTRACT

A pressing device for attaching a touch panel to a casing is disclosed. The pressing device includes a main body, a pressing mechanism, a mounting base for mounting and positioning the casing, a plurality of guiding poles, and a carrier for carrying the touch panel. The guiding poles pass through the pressing mechanism for guiding the pressing mechanism to move in a perpendicular direction corresponding to the mounting base. The pressing mechanism has a protruding portion for pressing the casing, and the protruding portion is formed corresponding to the outline of the casing, such that the pressing force applied on the casing is even and the casing would not sway. The main body has a plurality of tracks, so as to have a carrier with a large area moving thereon. Thus, the carrier has sufficient area for carrying a touch panel.

### 1. FIELD OF INVENTION

The present invention relates to a pressing device, and more particularly, to a pressing device for a touch panel of an electronic product.

### 2. BACKGROUND OF THE INVENTION

Touch panels are wildly used in commercial electronic products due to the easy operation. In the fabrication of these electronic products, the touch panel is pressed on the casing of the electronic product. In order to attach the touch panel to the casing of the electronic product, some pressing devices have been developed.

FIG. 1 shows the pressing device 1 in the prior art for touch panels. The pressing device 1 is used for pressing a touch panel to a casing of an electronic product. The pressing device 1 includes a base 11, a pressing mechanism 12, a carrier 13, a single track 14 disposed on the base 11 and a slidable seat 15 capable of sliding on the sinle track 14. A casing may be disposed on the carrier 13, and a touch panel may be carried on the slidable seat 15 so as to slide into the casing. The pressing mechanism 12 moves toward the carrier 13, and thus pushes and presses the carrier 13 to the casing, such that the touch panel is attached to the casing.

However, the casing cannot be positioned by the carrier 13 of the pressing device 1, and therefore the casing would sway on the carrier 13 due to uneven force applied on the casing. This results in that the touch panel cannot be effectively attached to the casing. Further, if the slidable seat 15 has large area, the slidable seat with large area cannot slide on the single track 14. Thus, the slidable seat 15 cannot have enough area for bigger touch panels.

Accordingly, there is a need to provide a pressing device for overcoming the above drawbacks in the prior art.

### SUMMARY OF THE INVENTION

It is an aspect of the present invention to provide a pressing device for improving pressing effect of a touch panel of an electronic product.

The present invention provides a pressing device for attaching a touch panel to a casing, wherein the casing has a window and an opening. The pressing device includes a main body having a plurality of tracks, wherein the tracks are separated with and parallel to one another; a mounting base disposed in the main body for mounting and positioning the casing; a carrier for carrying the touch panel, wherein the tracks are disposed through the carrier, and the carrier moves along the tracks and toward the carrier, thereby carrying the touch panel inside the casing to be corresponding in position to the window; a pressing mechanism disposed in the main body and having a protruding portion corresponding to an outline of the casing, wherein the pressing mechanism is allowed to move toward the carrier so as to press the casing mounted on the mounting base, such that the casing moves toward the carrier, the touch panel is pressed and attached inside the casing, and the window is thus closed; and a plurality of guiding poles passing through the pressing mechanism for guiding the pressing mechanism to move in a predetermined direction.

In one embodiment, there are a plurality of linear elastic components such as springs disposed in the mounting base and the main body, so as to raise or lower the mounting base corresponding to the main body. The mounting base may have a slot for positioning the casing. The mounting base has a through hole, and the main body has a supporting component passing through the through hole of the mounting base for supporting the carrier.

The pressing device further includes a first, a second and a third driving devices. The first driving device is connected to the pressing mechanism for driving the mechanism to move toward the mounting base. The second driving device is connected to the carrier for driving the carrier to move toward the mounting base. The third driving device is connected to the supporting component for driving the supporting component to protrude from the through hole of the mounting base so as to support the carrier. The first, second and third driving devices may be pressure cylinders or oil pressure cylinders.

The guiding poles are disposed around the pressing mechanism. The pressing mechanism and the mounting base have a pressing portion made of polytetrafluoroethylene. The carrier may include a carrier main body; a carrier plate having a surface for carrying the touch panel; a plurality elastic components disposed around the carrier plate, wherein each of the elastic components has both ends respectively connected to the carrier plate and the carrier main body, such that the carrier plate moves corresponding in position to the carrier main body; and a supporting component having two ends respectively contacting an intermediate portion between the carrier body and the carrier plate, wherein the supporting component is a pivot for the carrier plate to rotate around the carrier main body.

Further, the supporting component is a sphere, and the carrier main body has a portion for contacting the supporting component and positioning an interior concave surface. The carrier may further include a limiting component having two ends connecting to the carrier plate and the carrier main body so as to limit rotation of the carrier plate, wherein the limiting component may be an elastic multistage sleeve.

Hence, the present invention provides a pressing device for attaching a touch panel to a casing. The pressing device includes a main body, a pressing mechanism, a mounting base for mounting and positioning the casing, a plurality of guiding poles, and a carrier for carrying the touch panel. The guiding poles pass through the pressing mechanism for guiding the pressing mechanism to move in a perpendicular direction corresponding to the mounting base, and the pressing mechanism would not shift in horizontal direction corresponding to the mounting base upon the vertical movement, such that the pressing mechanism may effectively press and move the casing. The pressing mechanism has a protruding portion for pressing the casing, and the protruding portion is formed corresponding to the outline of the casing, such that the pressing force applied on the casing is even and the casing would not sway. The main body has a plurality of tracks, which are separated from and parallel to one another, so as to have a carrier with a large area moving thereon. Thus, the carrier has sufficient area for carrying a touch panel. Therefore, the pressing device of the present invention effectively improves the attachment of a touch panel to a casing.

### BRIEF DESCRIPTION OF THE DRAWINGS

FIG. 1 is a schematic view showing a pressing device for a touch panel in the prior art;

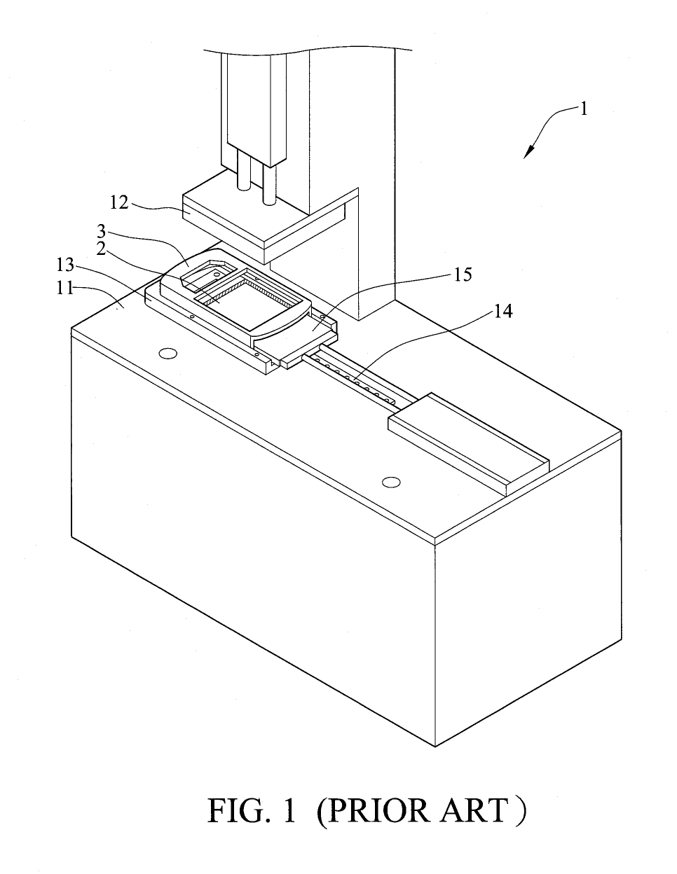

FIG. 2 and FIG. 3 are schematic view showing a pressing device according to the embodiment of the present invention;

FIG. 4 is the top view of the carrier in the pressing device of FIG. 2;

FIG. 5 is an enlarged view along the A-A line of the carrier in FIG. 4; and

FIG. 6 is a flow chart showing the steps of using the pressing device of the present invention for attaching a touch panel to a casing.

### DETAILED DESCRIPTION OF THE PREFERRED EMBODIMENTS

The following embodiments are used for illustrating the present invention. A person skilled in the art can easily conceive the other advantages and effects of the present invention.

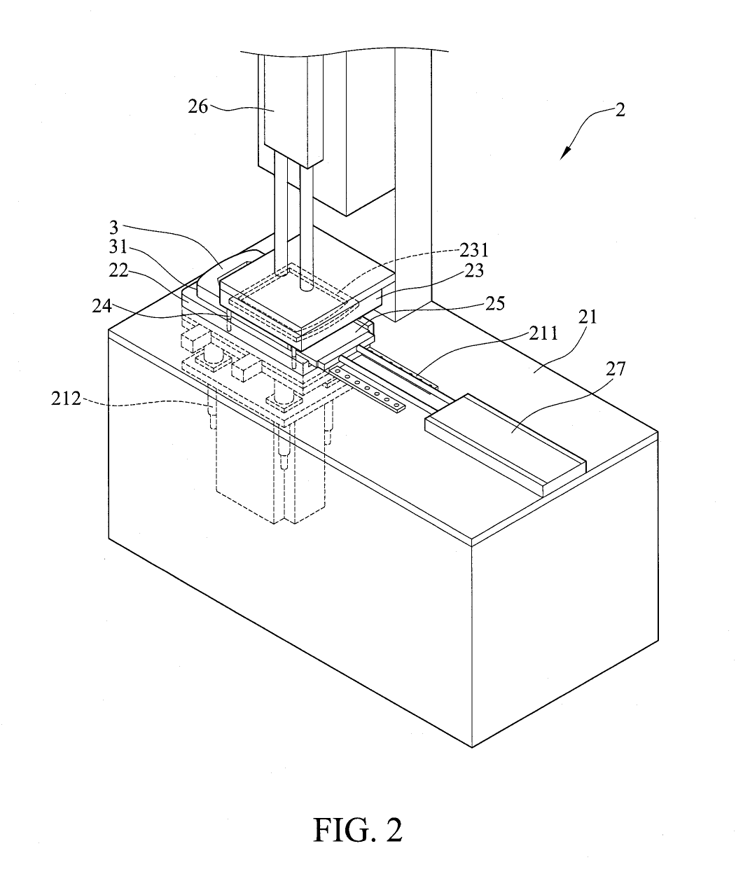

FIG. 2 and FIG. 3 are schematic views showing a pressing device 2 of the present invention. The pressing device 2 is used for attaching a touch panel 4 to a casing 3, wherein the casing 3 has a window 32 and an opening 3 and has a first positioning portion 31 on the periphery of the casing 3. The first positioning portion 31 may be a positioning plate. The pressing device 2 includes a main body 21, a mounting base 22, a pressing mechanism 23, a plurality of guiding poles 24 and a carrier 25. The mounting base 22 is disposed on the main body 21, and is movable upward and downward. The main body 21 includes a supporting component 213 for supporting the carrier 25 so as to prevent the carrier 25 from deformation and ensure the attachment of the touch panel 4 to the casing 3.

The main body 21 has four linear elastic components 212 and two tracks 211, wherein the tracks 21 are separated from and parallel to each other. Each linear elastic component 212 is disposed between the mounting base 22 and the main body 21, and has two ends respectively connected to the mounting base 22 and the main body 21, such that the mounting base 22 is allowed to raise or lower corresponding to the main body 21. Each of the linear elastic components 212 may be a spring. The two tracks 211 may allow the carrier 25 with a large area to move thereon, and thus the carrier 25 may provide sufficient area for carrying the touch panel 4 with a large area. The amount of these linear elastic components 212 and the tracks 211 may be optionally changed. Further, while the casing 3 is elastic, the linear elastic components 212 may be omitted.

The casing 3 may be mounted on the mounting base 22, and the mounting base 22 has a second positioning portion 221 corresponding to the first positioning portion 31 for positioning the casing 3. As shown in figures, the second positioning portion 221 of the mounting base 22 may be a slot. The mounting base 22 has a through hole 222, and the supporting component 213 protrudes from the through hole 222, such that the carrier 25 is supported by the supporting component 213. Certainly, the shape of the second positioning portion 221 may be changed in response to the first positioning portion 31, so as to effectively position the casing 3.

The pressing mechanism is disposed in the main body 21, and has a protruding portion 231 corresponding to the outline of the casing. The protruding portion 231 moves with the pressing mechanism 23 toward the mounting base 22, so as to press the casing 3 mounted on the mounting base 22. While the pressing mechanism 23 presses the casing 3, the casing 3 moves toward the carrier 25, such that the touch panel 4 is pressed and attached in the casing so as to seal the window 32. In addition, the pressing mechanism 23 pressing the periphery of the casing via the protruding portion 231, so as to prevent the casing 3 from having uneven force applied thereon, such that the casing 3 would not sway on the mounting base 22, and the protruding portion 231 effectively improve the attachment of the touch panel 4 to the casing 3. Hence, the yield of the electronic product having the casing 3 and the touch panel 4 is increased. Further, the pressing mechanism 23 and the mounting base 22 have a Teflon (polytetrafluoroethylene) pressing portion to extend the life of the pressing mechanism 23 and the mounting base 22 due to the Teflon having wear-resistance.

The guiding poles 24 pass through the pressing mechanism 23 for guiding the pressing mechanism 23 to move in a vertical direction corresponding to the mounting base 22, and the pressing mechanism 23 would not shift in a horizontal direction corresponding to the mounting base 22 upon movement, such that even the pressing device is used for many times, the pressing mechanism 23 still effectively presses and moves the casing 3 mounted on the mounting base 22.

The carrier 25 is disposed on the tracks 211 for carrying the touch panel 4, and the carrier 25 moves along the tracks 211 and toward the mounting base 22, such that the touch panel 4 is moved from the opening 33 to the corresponding window 32 in the casing 3 as shown in FIG. 2. While the casing 3 is pressed by the pressing mechanism 23, the casing 3 moves toward the carrier 25 for attaching with the touch panel 4 on the carrier 25, which is moved into the casing 3, and each linear elastic component 212 is deformed due to the above press and movement. Thus, the mounting base 22 is pressed and moved by the pressing mechanism 23.

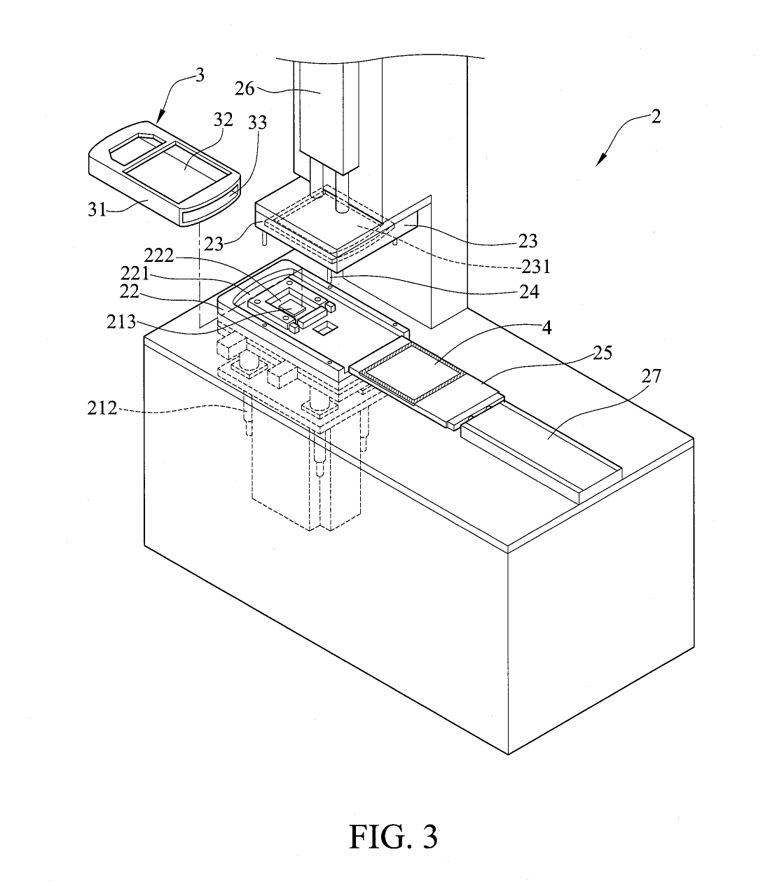

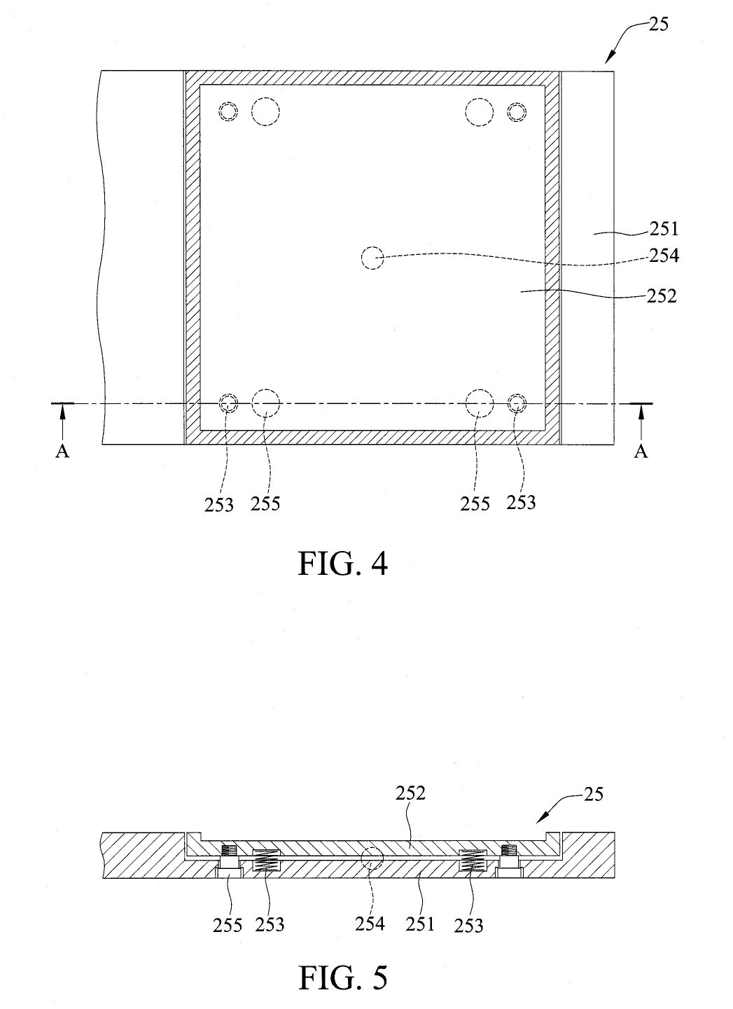

FIG. 4 and FIG. 5 show the carrier of the pressing device of the present invention. The carrier 25 further includes a carrier main body 251, a carrier plate 252, four elastic components 253 and a supporting component 254. The carrier plate 252 is disposed in the carrier main body 251, and has a surface for carrying the touch panel 4. Each of the elastic components 253 has two ends respectively connected to the carrier plate 252 and the carrier main body 251. The elastic components 253 are arranged around the carrier plate 252, such that the carrier plate 252 may recover upon the tilt resulting from the force applied thereon. The elastic components 253 may be springs. The amount and type of the elastic components 253 may be optionally changed.

The supporting component 254 has two ends respectively connected between the carrier main body 251 and the carrier plate 252 for being a pivot at which the carrier plate 252 rotates around the carrier main body 251. Therefore, while having force applied thereon, the carrier plate 252 may take the supporting component 254 as a pivot and tilt to the carrier main body 251. In addition, when the carrier plate 252 is forced to tilt, the carrier plate 252 may recover due to the elastic components 253. Hence, the carrier plate 252 may adapt to various sizes of the casing 3 and the touch panel 4 so as to ensure that the touch panel 4 is effectively attached to the casing 3. Accordingly, the pressing device 2 may improve the attachment of the touch panel 4 to the casing 3, and thus improve the yield of the electronic product. In this embodiment, the supporting component 254 is a sphere to be a pivot at which the carrier plate 252 rotates around the carrier main body 251. The carrier main body 251 has a portion with an interior concave surface for contacting and positioning the supporting component 254. Certainly, the supporting component 254 may have other shapes such as a cone shape. The carrier 25 further includes a limiting component 255 such as an elastic multistage cylinder. The limiting component 255 has two ends respectively connected to the carrier plate 252 and the carrier main body 251 for limiting the rotation of the carrier plate 252 around the carrier main body 251, so as to prevent the elastic components from flexible deformation due to the rotation of the carrier plate 252.

In the present embodiment, the pressing device 2 may further include a third driving device (not shown) connected to the supporting component 213 for driving the supporting component 213 to protrude from the through hole 222 of the mounting base 22 and supporting the carrier 25, so as to prevent the carrier 25 from deformation. As shown in FIG. 2, the pressing device 2 further includes a first driving device 26 connected to the pressing mechanism 23 for driving the pressing mechanism 23 to move toward the mounting base 22. In addition, the pressing device 2 further includes a second driving device 27 connected to the carrier 25 for driving the carrier to move toward the mounting base 22, so as to move the touch panel 4 into the casing 3. The first driving device 26 and the second driving device 27 may be, but not limited to, pressure cylinders or oil pressure cylinders.

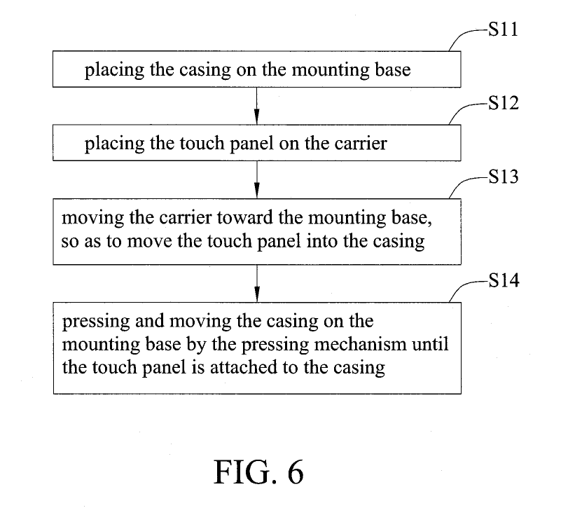

FIG. 6 is a flow chart showing that the pressing device 2 is used for attaching a touch panel to a casing. As shown in FIG. 6, in the step S11, the casing 3 is placed on the mounting base 22. In the step S12, the touch panel 4 is placed on the carrier 25. In the step S13, the carrier 25 moves along the tracks 211 and toward the mounting base 22, so as to move the touch panel 4 from the opening 33 into the corresponding window 32 of the casing 3, such that the supporting component 213 protrudes from the through hole 222 of the mounting base 22 for supporting the carrier 25, and the carrier 25 is prevented from deformation while having force applied thereon. In the step S14, the casing 3 on the mounting base 22 is pressed and moved by the pressing mechanism 23 of the pressing device 2, such that the casing moves toward the carrier 25 until the casing is attached with the touch panel 4, which is moved into the casing 3, such that the touch panel 4 is attached to the casing 3, and the window 32 is sealed to complete the attachment of the touch panel 4 to the casing 3.

Accordingly, the present invention provides a pressing device for attaching a touch panel to a casing. The pressing device includes a main body, a pressing mechanism, a mounting base for mounting and positioning the casing, a plurality of guiding poles, and a carrier for carrying the touch panel. The guiding poles pass through the pressing mechanism for guiding the pressing mechanism to move in a perpendicular direction corresponding to the mounting base, and the pressing mechanism would not shift in horizontal direction corresponding to the mounting base upon the vertical movement, such that the pressing mechanism may effectively press and move the casing. The pressing mechanism has a protruding portion for pressing the casing, and the protruding portion is formed corresponding to the outline of the casing, such that the pressing force applied on the casing is even and the casing would not sway. The main body has a plurality of tracks, which are separated from and parallel to one another, so as to have a carrier with a large area moving thereon. Thus, the carrier has sufficient area for carrying a touch panel. Therefore, the pressing device of the present invention effectively improves the attachment of a touch panel to a casing.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. A pressing device for attaching a touch panel to a casing, wherein the casing has a window and an opening, comprising:
a main body having a plurality of tracks, wherein the tracks are separated with and parallel to one another;
a mounting base disposed in the main body for mounting and positioning the casing;
a carrier for carrying the touch panel, wherein the tracks are disposed through the carrier, and the carrier moves along the tracks and toward the carrier, thereby carrying the touch panel into the casing to be corresponding in position to the window;
a pressing mechanism disposed in the main body and having a protruding portion corresponding to an outline of the casing, wherein the pressing mechanism is allowed to move toward the carrier, so as to press the casing mounted on the mounting base, such that the casing moves toward the carrier, the touch panel is pressed and attached into the casing, and the window is thus closed; and
a plurality of guiding poles passing through the pressing mechanism for guiding the pressing mechanism to move in a predetermined direction.

2. The pressing device of claim 1, further comprising a plurality of linear elastic components between the mounting base and the main body, thereby the mounting base being raised or lowered corresponding to the main body.

3. The pressing device of claim 2, wherein the linear elastic components are springs.

4. The pressing device of claim 1, wherein the mounting base has a slot for positioning the casing.

5. The pressing device of claim 1, wherein the mounting base has a through hole, and the main body has a supporting component passing through the through hole of the mounting base for supporting the carrier.

6. The pressing device of claim 5, further comprising a third driving device connected to the supporting component, so as to drive the supporting component to protrude from the through hole of the mounting base for supporting the carrier.

7. The pressing device of claim 6, further comprising a first driving device connected to the pressing mechanism, so as to drive the pressing mechanism to move toward the mounting base.

8. The pressing device of claim 7, further comprising a second device connected to the carrier, so as to drive the carrier to move toward the mounting base.

9. The pressing device of claim 8, wherein the first, second and third driving devices are pressure cylinders or oil pressure cylinders.

10. The pressing device of claim 1, wherein the guiding poles are disposed around the pressing mechanism.

11. The pressing device of claim 1, wherein the pressing mechanism and the mounting base have a pressing portion made of polytetrafluoroethylene.

12. The pressing device of claim 2, wherein the carrier comprises:
a carrier main body;
a carrier plate having a surface for carrying the touch panel;
a plurality elastic components disposed around the carrier plate, wherein each of the elastic components has both ends respectively connected to the carrier plate and the carrier main body, thereby the carrier plate moving corresponding in position to the carrier main body;
a supporting component having two ends respectively contacting an intermediate portion between the carrier body and the carrier plate, wherein the supporting component is a pivot for the carrier plate to rotate around the carrier main body; and
a limiting component having two ends connecting to the carrier plate and the carrier main body, thereby limiting rotation of the carrier plate.

13. The pressing device of claim 12, wherein the supporting component is a sphere, and the carrier main body has a portion having an interior concave surface for contacting and positioning the supporting component.

14. The pressing device of claim 12, wherein the limiting component is an elastic multistage sleeve.
